(19) United States
(12) Patent Application Publication
(10) Pub. No.: US 2025/0018332 A1
(43) Pub. Date: Jan. 16, 2025

(54) BIOGAS PURIFICATION UNIT

(71) Applicant: PRODEVAL SAS, CHATEAUNEUF SUR ISERE (FR)

(72) Inventors: Eric PEYRAT, TOULOUSE (FR); Sebastien PAOLOZZI, SAINT VINCENT DE LA COMMANDERIE (FR)

(73) Assignee: PRODEVAL SAS, CHATEAUNEUF SUR ISERE (FR)

(21) Appl. No.: 18/692,453

(22) PCT Filed: Sep. 19, 2022
(86) PCT No.: PCT/EP2022/075875

§ 371 Date: Sep. 23, 2024

(30) Foreign Application Priority Data
Sep. 17, 2021 (FR) FR2109793

(51) Int. Cl. B01D 53/22

(52) U.S. Cl. CPC B01D 53/228; B01D 53/225; B01D 2256/245; B01D 2258/05

(57) ABSTRACT

Disclosed is a purification unit (UE) configured to receive an inflow of biogas (BS) and to separate said received inflow of biogas (BS) into a stream of biomethane (BM), preferably containing at least 90% methane, and a stream of residual gases (GR1), referred to as combustion gases, the methane content of which is greater than 25%.

### TECHNICAL FIELD

The present invention pertains to the field of gas purification and relates more particularly to a purification unit enabling an incoming gas flow to be transformed into a flow of biomethane.

### BACKGROUND

It is known to treat an incoming flow of biogas in a purification unit in order to produce biomethane. Biomethane is a gas comprising at least 95% methane (CH₄), preferably more than 97% methane.

During purification, the incoming flow of biogas is separated into a flow of biomethane and a residual gas flow. This residual gas flow essentially comprises carbon dioxide (CO₂) but also methane, in a low proportion, which has not been able to be separated to return to the flow of biomethane.

This residual gas flow has for a long time been discharged into the atmosphere, but the latest standards in force prohibit discharges of gas flows of which the methane content is greater than a predetermined threshold. For example, in France this threshold is 0.5% vol. of methane maximum in discharges to the atmosphere and 0.2% vol. CH₄ maximum in Germany. Consequently, the residual gas flow must be reprocessed in order to comply with the discharge threshold.

Consequently, when the residual gases at the outlet of the purification unit have a content greater than the permitted threshold, it is necessary to put in place additional methods for processing residual gases in order to lower their methane content.

In one existing solution, this processing may be carried out by means of a method of oxidizing methane in catalytic reactors or regenerative burners (RTO or Regenerative Thermal Oxidizer type). This method constitutes the simplest and most economical existing solution to comply with discharge thresholds, but it has the drawback of not allowing the methane contained in the residual gases to be valorized (loss).

In another existing solution, this processing may be carried out by means of a method of trapping methane on an adsorbent medium (PSA-type method). In this method, in order to be recycled, the trapped methane is recovered then mixed again with the incoming flow of biogas at the inlet of the purification unit. However, this method may prove to be long and complex, and costly. Indeed, the recovery cost of this residual methane (CAPEX and OPEX) is significantly higher than its market value, which makes the investment unprofitable from an economic point of view.

In another existing solution, this processing may be carried out by means of a method of liquefaction of carbon dioxide with separation of methane, which remains incondensable at carbon dioxide liquefaction temperature and pressure conditions. The incondensable methane is recovered and recycled at the inlet of the biogas purification unit in order to be valorized. The sale of the liquid carbon dioxide produced makes it possible to finance the investment and operating costs of the liquefaction unit, but this method makes the installation complex, which can make maintenance expensive.

There is therefore a need for a simple and effective solution to overcome at least some of these drawbacks.

### SUMMARY

One of the aims of the invention is to propose a simple and efficient purification solution. Another aim of the invention is to enable better use of the residual gas flow.

To this end, the subject matter of the invention is firstly a purification unit configured to receive an incoming flow of biogas, for example from a biogas production module, and to separate said incoming flow of biogas received into a flow of biomethane, preferably containing at least 90% methane, and a so-called “combustion” residual gas flow, the methane content of which is greater than 25%.

In the present document, the term “biogas” is taken to mean “within the meaning of the ISO 20675 standard” which covers, notably, biogas produced by anaerobic fermentation (in the absence of air) of organic matter and “syngases”, which are gases obtained by methods such as pyrogasification, biological or catalytic methanation or any other method that leads to the production of a gaseous mixture composed essentially of methane and carbon dioxide.

The method according to the invention makes it possible to produce a combustion residual gas flow that is suitable for combustion in a combustion module, notably a cogeneration module such as for example a gas engine or a gas turbine, due to its minimum content of 25% methane. The production of such a combustion flow notably proves to be counterintuitive for those skilled in the art when one looks at the ways of processing residual gas flows derived from the purification of biogas in solutions of the prior art. Indeed, generating a residual gas flow with a non-negligible methane content would appear counterintuitive for those skilled in the art who wish, on the contrary, to extract as much methane as possible from the incoming flow of biogas. By producing a residual gas flow with a methane content of more than 25%, preferably greater than 30%, preferably still greater than 35%, it is thus possible to burn the combustion residual gas flow in a standard gas engine or a standard gas turbine in order to produce electricity, this electricity also being able advantageously to be used to supply electrical equipment enabling the operation of the purification unit.

Preferably, the purification unit comprises a plurality of membrane stages, preferably at least three membrane stages, configured to produce, from the incoming flow of biogas, a flow of biomethane, the methane content of which is greater than 90%, preferably greater than 95%, preferably still greater than 97%, and a combustion flow, the methane content of which is greater than 25%, preferably greater than 30%, preferably still greater than 35%. The terms “configured to produce” are taken to mean that the nature and layout of the membrane stages are chosen and adapted to obtain such methane contents on the outgoing flows.

In a first embodiment, the purification unit comprises:
a first membrane stage configured to receive the incoming flow of biogas and separate it into a first retentate and a first permeate,
a second membrane stage configured to receive the first retentate and separate it into a second retentate, corresponding to the flow of biomethane, and a second permeate that is recirculated in the incoming flow of biogas,
a third membrane stage configured to receive the first permeate and separate it into a third retentate, corresponding to the combustion flow, and a third permeate, which is recirculated in the incoming flow of biogas.

In a second embodiment, the purification unit comprises:
a first membrane stage configured to receive the incoming flow of biogas and separate it into a first retentate and a first permeate,
a second membrane stage configured to receive the first retentate and separate it into a second retentate, corresponding to the flow of biomethane, and a second permeate of which one part is recirculated in the incoming flow of biogas and another part is routed in the combustion flow,
a third membrane stage configured to receive the first permeate and separate it into a third retentate, routed in the combustion flow, and a third permeate, which is recirculated in the incoming flow of biogas.

In a third embodiment, the purification unit comprises:
a first membrane stage configured to receive the incoming flow of biogas and separate it into a first retentate and a first permeate,
a second membrane stage configured to receive the first retentate and separate it into a second retentate, corresponding to the flow of biomethane, and a second permeate of which one part is recirculated in the incoming flow of biogas and another part is routed in the combustion flow,
a third membrane stage configured to receive the first permeate and separate it into a third retentate, routed in the combustion flow, and a third permeate, of which one part is recirculated in the incoming flow of biogas and another part is routed in the combustion flow.

Advantageously, the purification unit is configured to separate said incoming flow of biogas received into a flow of biomethane, preferably containing at least 90% methane (preferably greater than 95%, preferably still greater than 97%), a combustion residual gas flow, the methane content of which is greater than 25% (preferably greater than 30%, preferably still greater than 35%), and a so-called “depleted” residual gas flow, the methane content of which is less than a predetermined threshold (and which is rich in carbon dioxide, preferably with a content greater than or equal to 85%, preferably still greater than or equal to 90%).

In one embodiment, the predetermined threshold is less than 0.5% vol. CH₄, preferably still less than 0.2% vol. CH₄. Thus, when the predetermined threshold is defined in relation to a standard for authorized methane discharge into the atmosphere (e.g. 0.2% vol. CH₄), the depleted flow may be discharged into the atmosphere.

In one embodiment, the predetermined threshold is less than 15% vol. CH₄, preferably less than 10%, in order to be able to valorize the depleted flow in a valorization module, for example by liquefaction or compression.

In one embodiment, the carbon dioxide content of the depleted flow is at least 85%, preferably at least 90%, in order to be able to be valorized in a valorization module, for example by liquefaction or compression.

In a fourth embodiment, the purification unit comprises:
a first membrane stage configured to receive the incoming flow of biogas and separate it into a first retentate and a first permeate,
a second membrane stage configured to receive the first retentate and separate it into a second retentate, corresponding to the flow of biomethane, and a second permeate, corresponding to the combustion flow,
a third membrane stage configured to receive the first permeate and separate it into a third retentate, which is recirculated in the incoming flow of biogas, and a third permeate, corresponding to the depleted flow, which may be discharged to the atmosphere or instead valorized to produce, for example, liquefied carbon dioxide.

In a fifth embodiment, the purification unit comprises:
a first membrane stage configured to receive the incoming flow of biogas and separate it into a first retentate and a first permeate,
a second membrane stage configured to receive the first retentate and separate it into a second retentate, corresponding to the flow of biomethane, and a second permeate, which is recirculated in the incoming flow of biogas,
a third membrane stage configured to receive the first permeate and separate it into a third retentate, corresponding to the combustion flow, and a third permeate, corresponding to the depleted flow, which may be discharged to the atmosphere or instead valorized to produce, for example, liquefied carbon dioxide.

In a sixth embodiment, the purification unit comprises:
a first membrane stage configured to receive the incoming flow of biogas and separate it into a first retentate and a first permeate,
a second membrane stage configured to receive the first retentate and separate it into a second retentate, corresponding to the flow of biomethane, and a second permeate of which one part is recirculated in the incoming flow of biogas and another part is routed in the combustion flow,
a third membrane stage configured to receive the first permeate and separate it into a third retentate, of which one part is recirculated in the incoming flow of biogas and another part is routed in the combustion flow, and a third permeate, corresponding to the depleted flow, which may be discharged to the atmosphere or instead valorized to produce, for example, liquefied carbon dioxide.

The invention also relates to a biomethane production system comprising:
at least one purification unit as presented previously, electrically supplied,
at least one residual gas combustion module configured to produce electricity by burning said combustion flow.

Preferably, the at least one residual gas combustion module is configured to provide at least a part of the electricity produced by burning the combustion flow to the at least one purification unit in order to electrically supply it to operate it (and/or all or part of its auxiliary electrical equipment).

The invention also relates to a biomethane production system comprising:
at least one purification unit as described above,
at least one valorization module configured to receive the depleted flow in order to valorize it, for example by carrying out its liquefaction or its compression.

The invention also relates to a biomethane production system comprising:
at least one purification unit as presented previously, electrically supplied,
at least one residual gas combustion module configured to produce electricity by burning said combustion flow, and/or
at least one valorization module configured to receive the depleted flow in order to valorize it, for example by carrying out its liquefaction or its compression.

Preferably, the at least one residual gas combustion module is configured to provide at least a part of the electricity produced by burning the combustion flow to the at least one purification unit in order to electrically supply it to operate it (and/or all or part of its auxiliary electrical equipment).

The invention also relates to a method for purifying an incoming flow of biogas, said method, implemented by a purification unit as presented previously, comprising the steps of:
reception of an incoming flow of biogas, for example provided by a biogas production module,
separation of said incoming flow of biogas received into a flow of biomethane, preferably containing at least 90% methane, preferably greater than 95%, preferably still greater than 97%, and a so-called “combustion” residual gas flow, the methane content of which is greater than 25%, preferably greater than 30%, preferably still greater than 35%.

In one embodiment, the separation of the incoming flow of biogas received is carried out into a flow of biomethane, preferably containing at least 90% methane (preferably greater than 95%, preferably still greater than 97%), a combustion residual gas flow, the methane content of which is greater than 25% (preferably greater than 30%, preferably still greater than 35%), and a so-called “depleted” residual gas flow, the methane content of which is below a predetermined threshold (and which is rich in carbon dioxide).

The invention also relates to a method for processing an incoming flow of biogas by a system as presented previously, said method comprising the steps of:
reception of an incoming flow of biogas, for example provided by a biogas production module,
separation of said incoming flow of biogas received into a flow of biomethane, preferably containing at least 90% methane, and a so-called “combustion” residual gas flow, the methane content of which is greater than 25%.
production of electricity by combustion of said combustion flow,
electrical supply of the at least one purification unit from at least a part of the electricity produced.

### BRIEF DESCRIPTION OF THE DRAWINGS

Further characteristics and advantages of the invention will further appear upon reading the description that follows. This is purely illustrative and should be read in conjunction with the appended drawings in which:

FIG. 1 schematically illustrates a purification unit according to the invention.

FIG. 2 schematically illustrates one embodiment of the purification unit according to the invention.

FIG. 3 schematically illustrates one embodiment of the system according to the invention.

FIG. 4 schematically illustrates another embodiment of the system according to the invention.

FIG. 5 schematically illustrates a first exemplary implementation of the method according to the invention.

FIG. 6 schematically illustrates a second exemplary implementation of the method according to the invention.

FIG. 7 schematically illustrates a third exemplary implementation of the method according to the invention.

FIG. 8 schematically illustrates a fourth exemplary implementation of the method according to the invention.

FIG. 9 schematically illustrates a fifth exemplary implementation of the method according to the invention.

FIG. 10 schematically illustrates a sixth exemplary implementation of the method according to the invention.

FIG. 11 schematically illustrates one embodiment of the method according to the invention.

### DETAILED DESCRIPTION

The system according to the invention makes it possible to process an incoming flow of biogas within the meaning of the ISO 20675 standard in order to transform it into biomethane and capture carbon dioxide at certain stages of the process and valorize some of the gas flows as will be explained hereafter. The terms “incoming flow of biogas within the meaning of the ISO 20675 standard” are taken to mean biogas produced by anaerobic fermentation (in the absence of air) of organic matter in a methanization unit or on a waste burial site as well as syngases. “Syngases” designates gases obtained by methods such as pyrogasification, biological or catalytic methanation or any other method that leads to the production of a gaseous mixture composed essentially of methane and carbon dioxide.

The system according to the invention enables the production of biomethane by purification of an incoming flow of biogas. The system comprises at least one purification unit according to the invention.

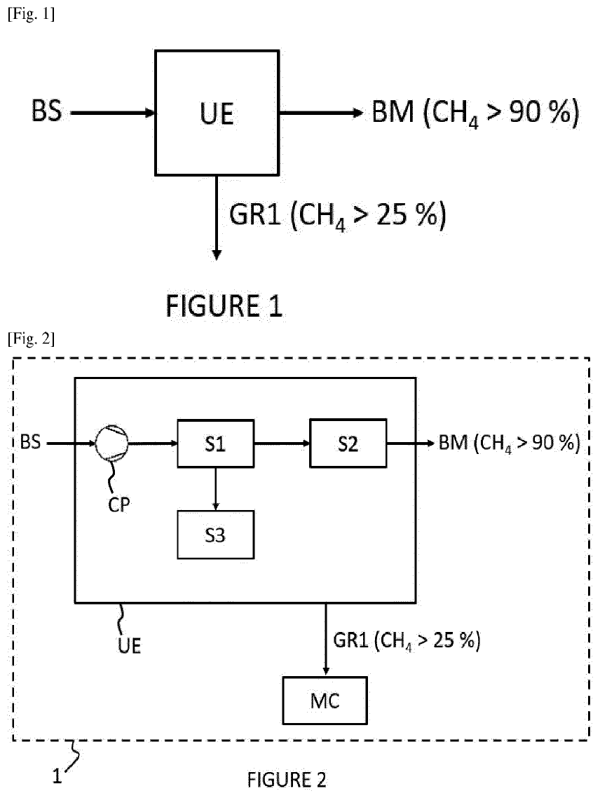

FIG. 1 shows a purification unit UE according to the invention and FIGS. 2 to 10 show examples of system 1 according to the invention.

In the examples of FIGS. 2 to 10, the system 1 comprises, for the sake of clarity, a single purification unit UE and further comprises a combustion module MC. It goes without saying that in another embodiment, the system 1 could comprise more than one purification unit UE.

With reference to FIG. 1, the purification unit UE is configured to receive an incoming flow of biogas BS, produced by a biogas production module (not represented). The purification unit UE is configured to separate the incoming flow of biogas BS received into a flow of biomethane BM comprising at least 90% methane and a so-called “combustion” residual gas flow GR1 comprising at least 25% methane.

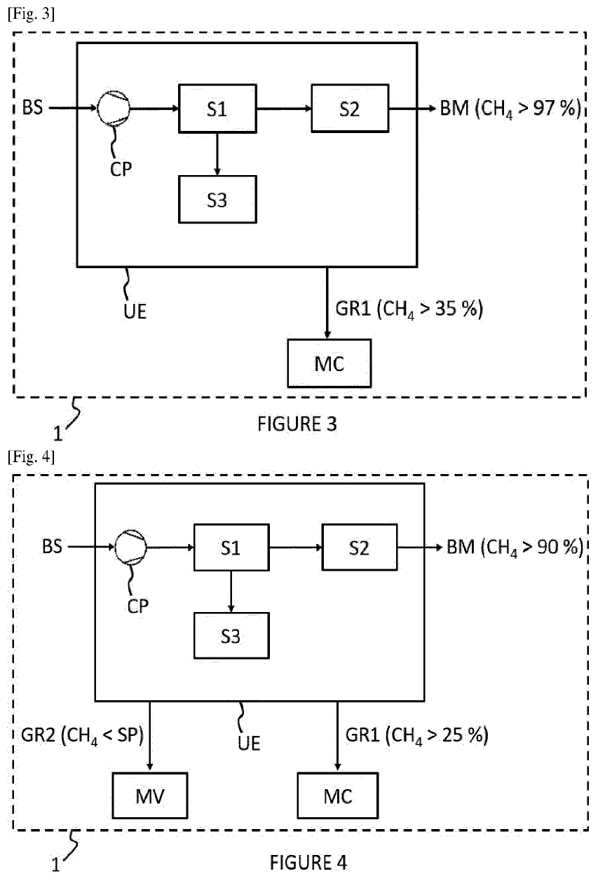

To this end, in the example of FIGS. 2 and 3 but in a non-limiting manner, the purification unit UE preferably comprises a plurality of membrane stages S1, S2, S3 adapted to separate the incoming flow of biogas BS into a plurality of outgoing flows. Within the scope of the invention, the number and properties of the membranes of each membrane stage S1, S2, S3 are chosen such that the retentate and permeate flows arising from the separation of the gas entering said stage S1, S2, S3 comprise predetermined methane contents. Notably, the flow of biomethane comprises at least 90% methane (FIG. 2), preferably more than 95% methane, preferably still more than 97% methane (FIG. 3). In addition, the methane content of the combustion flow is greater than 25% (FIG. 2), preferably greater than 30%, preferably still greater than 35% (FIG. 3).

In a known manner, the purification unit UE is electrically supplied to operate.

In the examples of FIGS. 2 to 10, the purification unit UE comprises a compressor CP, preferably electric, and three membrane stages S1, S2, S3. The compressor CP is configured to receive the incoming flow of biogas BS entering the purification unit UE in order to compress it (i.e. increase its pressure) at the inlet of the first membrane stage S1 and to make it circulate through the membrane stages S1, S2, S3.

The electrical supply of the purification unit UE may also allow the electrical supply of the auxiliary equipment of said purification unit UE such as ventilation devices, heating devices, air conditioning devices, lighting devices, a control cabinet, control automatons, motorized regulation members and/or instrumentation devices, etc.

The combustion module MC makes it possible to burn residual gases derived from the purification (i.e. the combustion flow GR1). Advantageously, the combustion module MC is configured to produce electricity by burning the combustion flow GR1 and to provide at least a part of the electricity produced to the at least one purification unit UE in order to electrically supply it, notably the compressor CP when it is electrical and/or auxiliary equipment of the purification unit UE. The combustion module MC may for example be of cogeneration module type, notably of the gas engine or gas turbine type.

In an advantageous embodiment of the system 1, an example of which is illustrated in FIG. 4, the purification unit UE is configured to separate the incoming flow of biogas BS received into:
a flow of biomethane BM preferably containing at least 90% methane, preferably more than 95% methane, preferably still more than 97% methane,
a combustion residual gas flow GR1, the methane content of which is greater than 25%, preferably greater than 30%, preferably still greater than 35%, and
a so-called “depleted” residual gas flow GR2, the methane content of which is below a predetermined threshold SP and which is rich in carbon dioxide.

The predetermined threshold SP is preferably defined in relation to a standard for authorized methane discharge into the atmosphere, e.g. 0.5% vol. CH₄ as is currently the case in France or 0.2% vol. CH₄ as is currently the case in Germany, so as to be able to discharge the depleted flow into the atmosphere in compliance with the standard.

Still in the embodiment illustrated in FIG. 4, the system 1 further comprises a valorization module MV configured to receive the depleted flow GR2 in order to valorize it, for example by carrying out its liquefaction in order to produce liquefied carbon dioxide.

### Exemplary Implementations

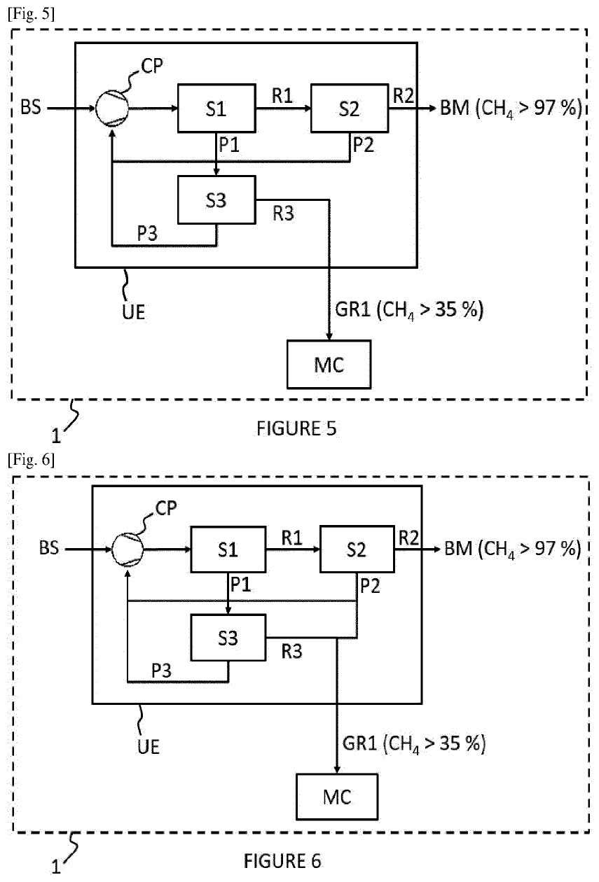

The method will be described in exemplary implementations with reference to FIGS. 5 to 11.

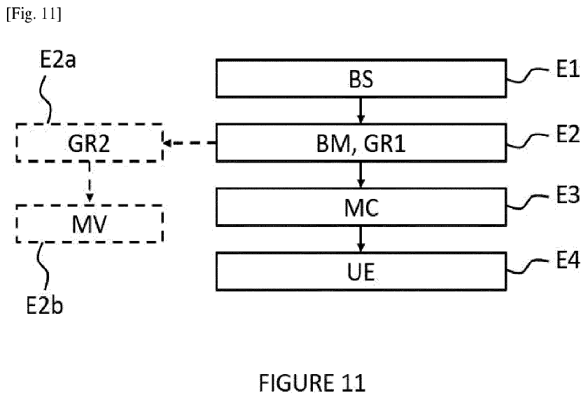

With reference to FIG. 11, the method according to the invention comprises a step E1 of reception of an incoming flow of biogas BS provided by a biogas production module (not represented) and a step E2 of separation of said incoming flow of biogas BS received into a flow of biomethane BM, preferably containing at least 90% methane, and a so-called “combustion” residual gas flow GR1, the methane content of which is greater than 25%.

Preferably, the method further comprises a step E3 of producing electricity by combustion of said combustion flow GR1 in the combustion module MC.

Preferably, the method further comprises a step E4 of electrically supplying the purification unit UE from at least a part of the electricity produced by the combustion module MC from the combustion of the combustion flow GR1.

### EXAMPLES 1 (FIG. 5)

The first membrane stage S1 is configured to receive the incoming flow of biogas BS and separate it into a first retentate R1 and a first permeate P1.

The second membrane stage S2 is configured to receive the first retentate R1 and separate it into a second retentate R2, corresponding to the outgoing flow of biomethane BM, and a second permeate P2 which is recirculated in the incoming flow of biogas BS.

The third membrane stage S3 is configured to receive the first permeate P1 and separate it into a third retentate R3, routed in the combustion flow GR1 to the combustion module MC, and a third permeate P3, which is recirculated in the incoming flow of biogas BS.

### EXAMPLE 2 (FIG. 6)

The first membrane stage S1 is configured to receive the incoming flow of biogas BS and separate it into a first retentate R1 and a first permeate P1.

The second membrane stage S2 is configured to receive the first retentate R1 and separate it into a second retentate R2, corresponding to the flow of biomethane BM, and a second permeate P2 of which one part is recirculated in the incoming flow of biogas BS and another part is routed in the combustion flow GR1 to the combustion module MC.

The third membrane stage is configured to receive the first permeate P1 and separate it into a third retentate R3, routed in the combustion flow GR1 to the combustion module MC, and a third permeate P3, which is recirculated in the incoming flow of biogas BS.

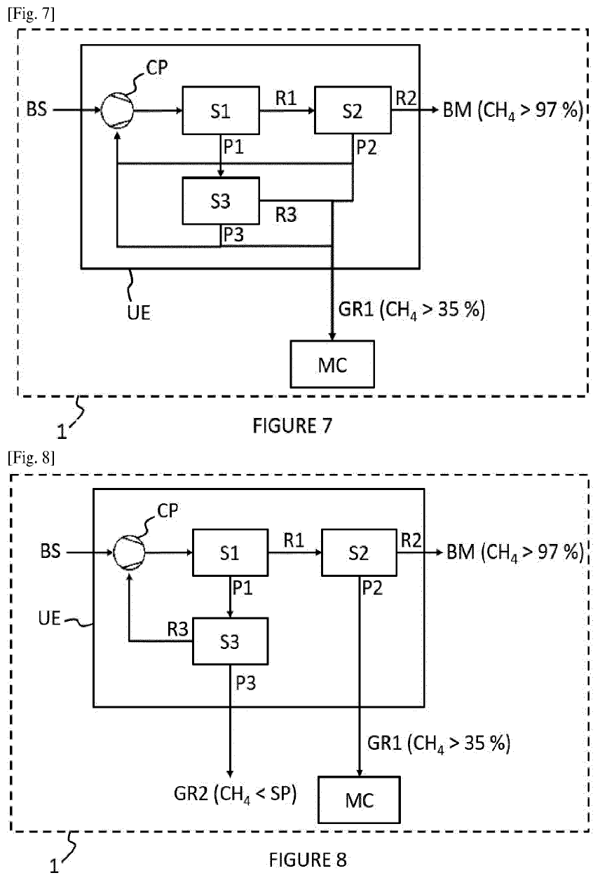

### EXAMPLE 3 (FIG. 7)

The first membrane stage S1 is configured to receive the incoming flow of biogas BS and separate it into a first retentate R1 and a first permeate P1.

The second membrane stage S2 is configured to receive the first retentate R1 and separate it into a second retentate R2, corresponding to the flow of biomethane BM, and a second permeate P2 of which one part is recirculated in the incoming flow of biogas BS and another part is routed in the combustion flow GR1 to the combustion module MC.

The third membrane stage S3 is configured to receive the first permeate P1 and separate it into a third retentate R3, routed in the combustion flow GR1, and a third permeate P3, of which one part is recirculated in the incoming flow of biogas BS and another part is routed in the combustion flow GR1 to the combustion module MC.

In the embodiments of the following examples 4 to 6 (FIGS. 8 to 10 respectively) and with reference to FIG. 11, the separation of the incoming flow of biogas BS received is carried out into a flow of biomethane BM, the methane content of which is greater than 90% (preferably greater than 95%, preferably still greater than 97%), a combustion residual gas flow GR1, the methane content of which is greater than 25% (preferably greater than 30%, preferably still greater than35%), and a so-called “depleted” residual gas flow GR2 (step E2a carried out simultaneously with step E2 in the purification unit UE). The methane content of this depleted residual gas flow GR2 is preferably below a predetermined threshold SP (and which is rich in carbon dioxide), for example defined by a standard in order to be able to discharge said depleted flow GR2 into the atmosphere. The depleted residual gas flow GR2 may thus either be discharged to the atmosphere if it complies with the predetermined threshold or instead, whatever its methane content, valorized in a valorization module MV, for example in order to produce liquefied carbon dioxide (step E2b).

### EXAMPLE 4 (FIG. 8)

The first membrane stage S1 is configured to receive the incoming flow of biogas BS, accelerated by the compressor CP, and separate it into a first retentate R1 and a first permeate P1.

The second membrane stage S2 is configured to receive the first retentate R1 and separate it into a second retentate R2, corresponding to the flow of biomethane BM exiting the purification unit UE, and a second permeate P2, corresponding to the combustion flow GR1 which is routed to the combustion module MC.

The third membrane stage S3 is configured to receive the first permeate P1 and separate it into a third retentate R3, which is recirculated (i.e. routed) in the incoming flow of biogas BS, and a third permeate P3, which corresponds to the depleted residual gas flow GR2 and which may be discharged to the atmosphere or instead valorized in a valorization module MV, for example to liquefy the carbon dioxide it contains.

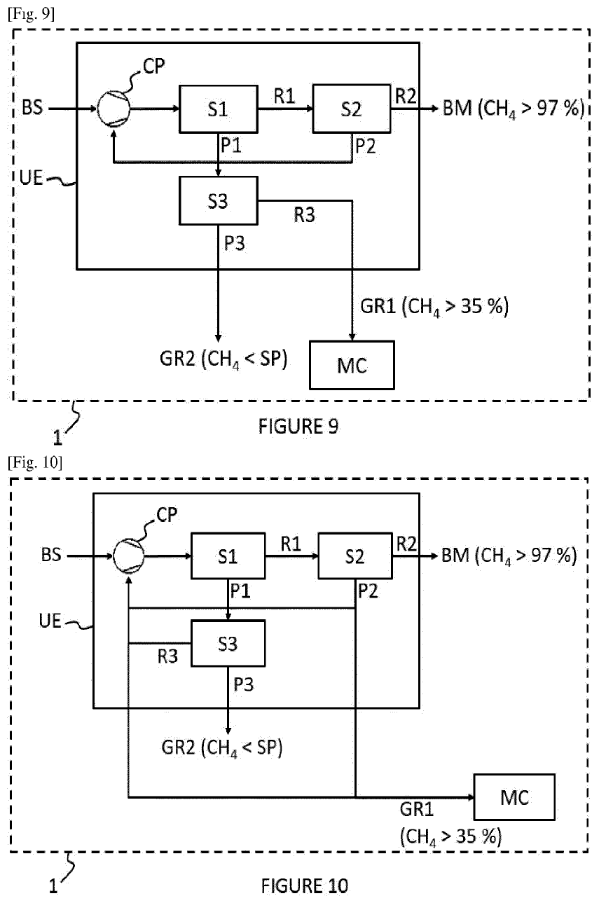

### EXAMPLE 5 (FIG. 9)

The first membrane stage S1 is configured to receive the incoming flow of biogas BS and separate it into a first retentate R1 and a first permeate P1.

The second membrane stage S2 is configured to receive the first retentate R1 and separate it into a second retentate R2, corresponding to the outgoing flow of biomethane BM, and a second permeate P2, which is recirculated in the incoming flow of biogas BS.

The third membrane stage S3 is configured to receive the first permeate P1 and separate it into a third retentate R3, corresponding to the combustion flow GR1 which is routed to the combustion module MC, and a third permeate P3, which corresponds to the depleted residual gas flow GR2 and which may be discharged to the atmosphere or instead valorized in a valorization module MV, for example to liquefy the carbon dioxide that it contains.

### EXAMPLE 6 (FIG. 10)

The first membrane stage S1 is configured to receive the incoming flow of biogas BS and separate it into a first retentate R1 and a first permeate P1.

The second membrane stage S2 is configured to receive the first retentate R1 and separate it into a second retentate R2, corresponding to the outgoing flow of biomethane BM, and a second permeate P2 of which one part is recirculated in the incoming flow of biogas BS and another part is routed in the combustion flow GR1 to the combustion module MC.

The third membrane stage S3 is configured to receive the first permeate P1 and separate it into a third retentate R3, of which one part is routed in the combustion flow GR1 to the combustion module MC and another part is recirculated in the incoming flow of biogas BS via the compressor CP, and a third permeate P3, corresponding to the depleted flow of residual gas GR2, which may be discharged to the atmosphere or instead valorized in a valorization module MV, for example, to liquefy the carbon dioxide that it contains.

The invention therefore advantageously makes it possible to valorize all or part of the outgoing flows derived from the purification.

1. Purification unit (UE) constituted of three membrane stages (S1, S2, S3) configured to receive an incoming flow of biogas (BS) and to separate said incoming flow of biogas (BS) received into:
a flow of biomethane (BM), containing at least 90% methane,
a so-called “combustion” residual gas flow (GR1), the methane content of which is greater than 25%,
a so-called “depleted” residual gas flow (GR2), the methane content of which is below a predetermined threshold (SP).

2. Purification unit (UE) according to claim 1, comprising:
a first membrane stage (S1) configured to receive the incoming flow of biogas (BS) and separate it into a first retentate (R1) and a first permeate (P1),
a second membrane stage (S2) configured to receive the first retentate (R1) and separate it into a second retentate (R2), corresponding to the flow of biomethane (BM), and a second permeate (P2), corresponding to the combustion flow (GR1),
a third membrane stage (S3) configured to receive the first permeate (P1) and separate it into a third retentate (R3), which is recirculated in the incoming flow of biogas (BS), and a third permeate (P3), corresponding to the depleted flow (GR2).

3. Purification unit (UE) according to claim 1, comprising:
a first membrane stage (S1) configured to receive the incoming flow of biogas (BS) and separate it into a first retentate (R1) and a first permeate (P1),
a second membrane stage (S2) configured to receive the first retentate (R1) and separate it into a second retentate (R2), corresponding to the flow of biomethane (BM), and a second permeate (P2), which is recirculated in the incoming flow of biogas (BS),
a third membrane stage (S3) configured to receive the first permeate (P1) and separate it into a third retentate (R3), corresponding to the combustion flow (GR1), and a third permeate (P3), corresponding to the depleted flow (GR2).

4. Purification unit (UE) according to claim 1, comprising:
a first membrane stage (S1) configured to receive the incoming flow of biogas (BS) and separate it into a first retentate (R1) and a first permeate (P1),
a second membrane stage (S2) configured to receive the first retentate (R1) and separate it into a second retentate (R2), corresponding to the flow of biomethane (BM), and a second permeate (P2) of which one part is recirculated in the incoming flow of biogas (BS) and another part is routed in the combustion flow (GR1),
a third membrane stage (S3) configured to receive the first permeate (P1) and separate it into a third retentate (R3), of which one part is routed in the combustion flow (GR1) to the combustion module (MC) and another part is recirculated in the incoming flow of biogas (BS), and a third permeate (P3), corresponding to the depleted flow (GR2).

5. Purification unit (UE) according to any one of the preceding claims, wherein the predetermined threshold (SP) is 10%, to valorize the depleted flow (GR2) in a valorization module (MV), for example by liquefaction or compression, or instead 0.5% vol. of methane to be able to discharge the depleted flow (GR2) into the atmosphere.

6. System (1) for producing biomethane (BM) comprising:
at least one purification unit (UE) according to any one of the preceding claims, electrically supplied,
at least one residual gas combustion module (MC) configured to produce electricity by burning said combustion flow (GR1), and/or
at least one valorization module (MV) configured to receive the depleted flow (GR2) in order to valorize it.

7. Method of purification (UE) of an incoming flow of biogas (BS), said method, implemented by a purification unit (UE) according to any one of the preceding claims, comprising the steps of:
reception (E1) of an incoming flow of biogas (BS),
separation (E2) of said incoming flow of biogas (BS) received into a flow of biomethane (BM), preferably containing at least 90% methane, a so-called “combustion” residual gas flow (GR1), the methane content of which is greater than 25%, and a depleted residual gas flow (GR2), the methane content of which is less than a predetermined threshold (SP).

8. Method according to the preceding claim, comprising a step of combustion of the combustion residual gas flow (GR1) in a combustion module (MC).

9. Method according to any one of claim 7 or 8, wherein, the methane content of the depleted residual gas flow (GR2) being less than 0.5%, preferably less than 0.2%, the method comprises a step of discharging the depleted residual gas flow (GR2) into the atmosphere.

10. Method according to any one of claim 7 or 8, comprising a step of valorization of the depleted flow (GR2) in a valorization module, for example to liquefy or compress it.
